(19) United States
(12) Patent Application Publication
(10) Pub. No.: US 2003/0074209 A1
(43) Pub. Date: Apr. 17, 2003

(54) User device with service finding and purchasing functionality

(76) Inventor: Christopher M. Tobin, McLean, VA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/981,342

(22) Filed: Oct. 15, 2001

(51) Int. Cl. G06F 17/60

(52) U.S. Cl. 705/1

(57) ABSTRACT

A user device couples to a position determining system to determine relative positions of the device and a service vendor. The position determining system may include an information database that provides the device with information about the service vendor. A display may be coupled to the device to display the relative positions and the information about the service vendor on a map. Additionally, the device includes a device identifier to authorize a transaction without revealing the identity of a user of the device.

### RELATED APPLICATIONS

This application claims the benefit of U.S. Provisional Application Serial No. 60/34,379 filed on Dec. 8, 2000, which is hereby incorporated by reference.

### FIELD OF THE INVENTION

The invention generally relates to an electronic user device, and in particular, to a user device that finds services and allows purchases by the user of the device.

### BACKGROUND OF THE INVENTION

When traveling, the consumer is often a captive purchaser, tending to buy gasoline and other products and services from the first available location. Although current positioning technology, such as the Global Positioning System (GPS), can pinpoint a consumer's location on a displayed map, it typically does not interface with service vendor data to display service vendor locations to a user. Internet-based direction finding services exist, and automobiles are being equipped with onboard GPS navigation and map systems. Some of these systems, allow a consumer to search for particular service vendors by category (e.g. hotels), by name, or by affiliation. However, conventional systems, which tend to have slow search and uploading times, provide limited search capabilities designed more for stationary than mobile users.

For example, conventional service maps will not allow consumers to search for service vendors by price, coupon, electronic payment capabilities. Nor will it search for the service vendor closest to the user. Additionally, the user is not provided with indications of real-time distances and travel times. Instead, direction finding companies only provide an alphabetical listing of service vendors within a circular area having a center point at the user's geographic location. If more service vendors are desired, the radius of the circular area is extended outwards.

Thus, neither the direction finding companies nor the onboard vehicular navigation systems provide a mechanism for finding a lowest price service vendor, or a closest service vendor, in a region radially near a mobile consumer's dynamically changing geographical position. Furthermore, in making such purchases, particularly gasoline purchases, consumers pay either by cash or by credit card. Many gasoline fuel terminals are now automated, but when the consumer pays by credit card, no measures are taken to ensure the privacy of the user.

### SUMMARY OF THE INVENTION

A user device couples to a position determining system to determine relative positions of the device and a service vendor. The position determining system may include an information database that provides the device with information about the service vendor. A display may be coupled to the device to display the relative positions and the information about the service vendor on a map. Additionally, the device includes a device identifier to authorize a transaction without revealing the identity of a user of the device.

### BRIEF DESCRIPTION OF THE DRAWINGS

The present invention is illustrated by way of example and not limitation in the figures of the accompanying drawings, in which:

FIG. 1A is a diagram of an embodiment of a user device coupled with electronic commerce and position determining systems.

FIG. 1B is a diagram of an embodiment of a user device illustrating one embodiment of a graphical user interface usable with the user device of FIG. 1A.

FIG. 1C is a diagram of another embodiment of a graphical user interface for use with the user device of FIG. 1A.

FIG. 2 is a process chart depicting one embodiment of a process to perform a transaction using the user device of FIG. 1A.

FIG. 3 is a simplified block diagram of one embodiment of a secure transaction system.

FIG. 4 is a simplified block diagram of one embodiment of a privacy card for a personal transaction device.

FIG. 5 is a simplified block diagram of one embodiment of a digital wallet for a personal transaction device.

FIG. 6 is a diagram illustrating one embodiment of a personal transaction device.

FIGS. 7A-7E are flow diagrams of one embodiment of a method usable with the user device of FIG. 1A.

### DETAILED DESCRIPTION OF PREFERRED EMBODIMENTS

In the following descriptions for the purposes of explanation, numerous details are set forth in order to provide a thorough understanding of the invention. However, it will be apparent to one skilled in the art that these specific details are not required in order to practice the invention. In other instances, well known electrical structures or circuits are shown in block diagram form in order not to obscure the invention unnecessarily.

In one embodiment, a user device is equipped with a service vendor locator program, which determines and displays a plurality of service vendor locations on a map, together with information specific to each service vendor, such as pricing and coupon information. This allows the consumer to make educated decisions about where to buy products, such as gasoline, without having to drive around making price comparisons. In one embodiment, the user device receives its current location from a Global Positioning System (GPS) and creates a default map for that location. The map may indicate the user device's current variable position in the center of, for example, approximately a five mile radius of map data, together with the fixed positions of a plurality of service vendors. In one embodiment, the map data resides entirely on a server, and the user device downloads appropriate map data based upon the user's position. In another embodiment, the map information resides on the user device, which only downloads supplemental information (e.g. service vendor locations, prices, etc.) to conserve bandwidth.

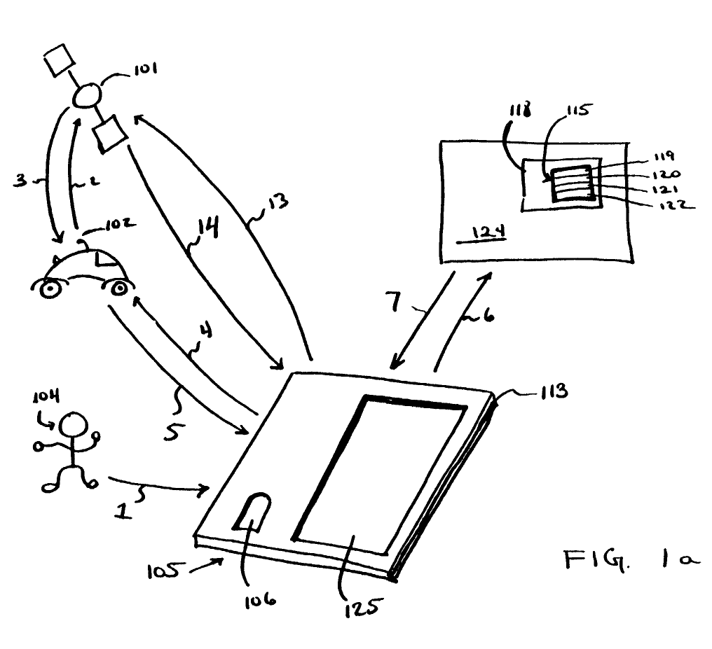

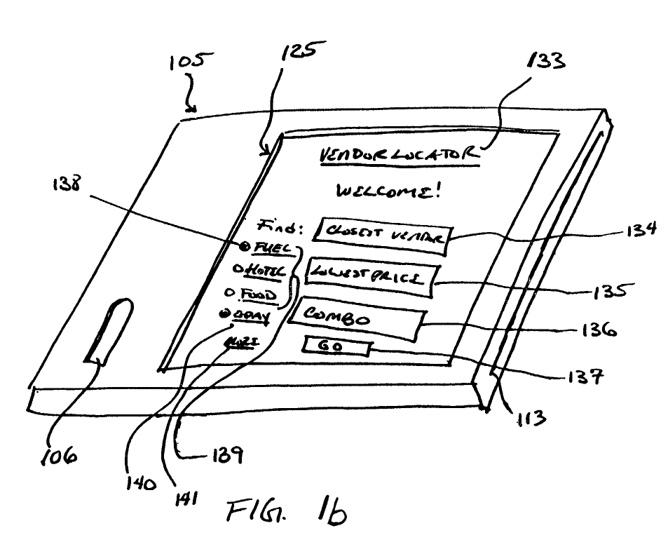

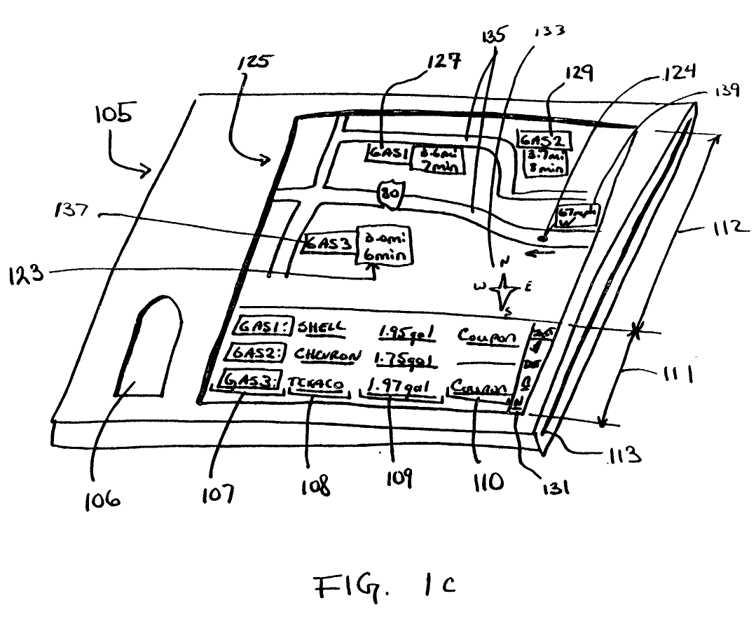

FIG. 1A illustrates one embodiment of the user device. The user device 105 is coupled to a position determining system (PDS) 101 and may also be coupled to a remote server 124 that hosts an information database 118 containing service vendor data 115. The user device 105 is activated and operated by a user 104 to conduct informational and purchasing transactions without compromising the user's personal identification information and identity. The user device 105 includes a display screen 125, such as a standard display or a touch sensitive screen, either color or gray-scale. The user device 105 may include a security device 106 to authenticate the user upon activation, such as a biometric device. The user device 105 may further include a voice recognition system, a keypad, a cursor control device, and a magnetic strip mechanism 113. Magnetic strip mechanism 113 may read and/or encode credit cards, smart cards, or privacy cards. Additionally, user device 105 may wirelessly couple with a personal digital assistant (PDA), a laptop computer, a desktop computer, or other electronic/digital system, when commanded to do so by a user, for as long as is needed to complete a user-initiated transaction.

The user device may couple with the position determining system (PDS) 101 in several ways. In one embodiment, wireless communication channels 13 and 14 are used, and user device 105 is equipped with a GPS signal processor necessary to determine the current spatial position of user device 105. Where processing speeds and power consumption are concerns, wireless communication channels 6 and 7 may be used to relay the GPS signals received by user device 105 to the remote server 124 for processing. In one embodiment, the position coordinates of user device 105 are calculated at the remote server 124 and transmitted to user device 105, where they are integrated visually and/or audibly with a map system and display.

In another embodiment, user device 105 couples with PDS 101 indirectly using (wireless) communication channels 4 and 5, and wireless communication channels 2 and 3. This embodiment takes advantage of the growing number of onboard navigation systems 102 currently being installed in vehicles 103, such as automobiles. Because the position calculations may be handled by the vehicle's onboard navigation system, user device 105 need not be equipped with its own GPS processor. Consequently, the production costs of user device 105 are lowered and design is simplified.

According to one embodiment, communications channels 4 and 5 are not wireless channels, and user device 105 physically couples to the vehicle's onboard navigation system using a synchronization cradle and/or cables connected to the vehicle. In a further embodiment, communications channels 4 and 5 are wireless channels. In this one embodiment, making the user device compatible with wireless standards such as Bluetooth allows user device 105 to communicate with various navigation and communications systems onboard vehicle 103. While Bluetooth is a cable-replacement technology created by Ericcson, and a standard for a small, cheap radio chip that can be plugged into computers, printers, mobile phones, etc. Bluetooth specifications and profiles are well known to persons skilled in the art.

FIG. 1B is a diagram of one embodiment of a graphical user interface for use with personal transaction device 105. In one embodiment, user device 105 displays the graphical user interface on display screen 125. A program title 133 may appear at the top of the screen, and combination of buttons 134, 135, 136, 137, 138, and hyperlinks 139 are provided to enable a user to request a particular type of desired search. A hyperlink is an element in an electronic document that links to another place in the same document or to an entirely different document. Commonly, a hyperlink is represented by either an icon (graphical image) or by an underlined word. Clicking on the hyperlink displays another webpage. Hyperlinks are an essential ingredient of all hypertext systems, including the World Wide Web.

The user device 105 may be equipped with a service vendor locator program, which is executed on the personal transaction device to locate all service vendors within a pre-determined radius of the current spatial position of user device 105. In one embodiment, the phrase “Service Vendor Locator” is centered at the top of the display screen as a program title 133. Two columns, each having a series of ventries, may be positioned beneath the program title 133. The entries in the first column may consist of a button 138 located adjacent hyperlink 139. In one embodiment, hyperlinks 139 include a “fuel” hyperlink, a “hotel” hyperlink, and a “food” hyperlink. Additionally, an “electronic payment” hyperlink 140 and a “More” hyperlink 141 may appear at the bottom of the list of hyperlinks 139. Activating “More” hyperlink 141 may display a list of additional hyperlinks, which indicate additional categories of service vendors, such as repair shops, movie theaters, etc. In FIG. 1B, each hyperlink is illustratively represented by an underlined word. It will be appreciated that the hyperlinks 139, 140, and 141 may take any conceivable form, such as icons that represent objects or programs.

In one embodiment, the second column is located to the right of the first, and the entries in the second column are buttons (a small outlined area in a dialog box or other area of a display screen that can be activated to select an option or command). Exemplary types of buttons shown in FIG. 1B, include: a “Closest Service Vendor” button 134; a “Lowest Price” button 135; a “Combination” button 136; and a “Go” button 137.

A user may search for available service vendors by activating various combinations of buttons and hyperlinks. For example, selecting the Fuel button 138 and activating the Go button 137 may display a list of all Fuel (gasoline) service vendors in a particular area. In a further embodiment, the positions of the service vendors found as a result of the search may be graphically represented on an electronic map. Similar searches for hotels and restaurants may also be performed as described above. These searches may be further restricted by activating one or more of buttons 134-137 and Electronic Payment hyperlink 140. For example, selecting Fuel button 138, activating the Closest Service vendor button 134, and activating the Go button 137, displays a list of the service vendors closest to the spatial location of the user device, for example, out to approximately a five (5) mile radial limit as measured from the user device. In a further embodiment, the locations of the service vendors are displayed on a local area map and/or audibly conveyed to the user. In yet another embodiment, Electronic Payment button 140 may be used in combination with one of buttons 134-136 to display a list of service vendors that host electronic commerce payment transactions. Similar restrictive searches for hotels and restaurants may also be performed as described above.

In one embodiment, a user may search for a favorite service vendor by activating one or service vendor hyperlinks 139. For example, activating Fuel hyperlink 139 may display a list of available Fuel service vendors within a predetermined spatial area. Selecting a service vendor from the list and activating the Go button 137 may display the locations of the selected service vendor(s) on a map. Similar searches for favorite hotel or food service vendors may be performed as described above.

FIG. 1C is a diagram of another embodiment of a graphical user interface for use with user device 105. Illustratively, display screen 125 is divided into two sections, an upper portion 112, and a lower portion 111. Upper portion 112 displays a local area map, which shows the positions of roads 135, service vendors 137, 127, and 129, and position 124 of user device 105. Also shown on the map are real-time distance and time information for each service vendor, the real-time speed and direction 139 of user device 105, and a compass indicator 133. In one embodiment, the distance and time information particular to each service vendor is shown in a small data box adjacent to the service vendor logo. For example, data box 123 displays the real-time time and distance information for service vendor 137, which is a Texaco™ station. The time information displays the estimated remaining travel time, calculated by dividing the approximate distance separating the Texaco™ station from user device 105 by the speed of user device 105. The distance information displays the approximate distance in miles or kilometers separating user device 105 from the service vendor 137. Similar data boxes are provided for other service vendors 127 and 129. In one embodiment, the closest service vendor is highlighted. Similar highlighting may be used to indicate the results of a search restricted by other criteria, such as the Electronic Payment button, the lowest price button, and/or the combination button, described above. In one embodiment, the speed and heading information 139 of user device 105 are provided by a server-based, vehicle-based, or user device-based GPS signal processor.

Lower portion 111 contains a menu bar 131 and a table having four columns. The first column 107 contains a series of icons identifying particular service vendors. In one embodiment, the icons are small pictures of service vendor logos. The second column 108 contains a series of service vendor hyperlinks, as previously described. The third column 109 contains hyperlinks to service vendor prices. The fourth column 110 contains hyperlinks to the service vendor coupons. In one embodiment, where no service vendors are available in a particular area, an appropriate message may be visually displayed and/or audibly generated. Clicking on a service vendor logo in column 107 (or in upper portion 112) or on a service vendor hyperlink in column 108, may display other information uniquely associated with that service vendor, such as the service vendor's street address and phone number, links to driving directions, etc. Similarly, clicking on a Price hyperlink in column 109 may display a listing of prices for additional products and services offered by that service vendor, such as other grades of fuel, carwashes, snacks, etc. Similarly, clicking on a Coupon hyperlink, if one is available, in column 110, displays more information regarding special sales or discounts offered by a particular service vendor.

In one embodiment, a Sort toolbar 131 is provided to allow a user to arrange the data displayed in lower portion 111 in a preferred fashion. Sort toolbar 131 may contain four sort icons, which may be of any size, type, or color, so long as their meaning is clear to the average user. For example, a “$” symbol may be provided to rank the service vendor information by price, in which the service vendors having the lowest prices first are listed, followed by a listing of other service vendors having higher prices. A command to rank the service vendor information by distance, listing service vendors from the closest to the farthest, may be represented by a Distance icon. Similarly, a command to rank the service vendor information, listing first all the service vendors having coupons, followed by all those who do not, may be represented by a Coupon icon. Additionally, a command to rank the service vendor information alphabetically by name, may be represented by a Name icon.

In one embodiment, the map data displayed in upper portion 112 and the service vendor information displayed in lower portion 111 are retrieved from an information database (of FIG. 1A) while the real-time distance and time information displayed in upper portion 112 are retrieved from an internal processor or from a remote server. To conserve bandwidth, user device 105 may be configured to store map data internally, so that accessing an information database (of FIG. 1A) would entail only downloading service vendor locations, pricing, coupon information, logos, etc.

In one embodiment, at least a portion of the service vendor data, such as price, is real-time (or semi-real-time) information, meaning that the information is updated by the respective service vendors as the data changes. In one embodiment, a service vendor enters price changes (or other data) into its computer system and those changes are automatically uploaded to the information database (of FIG. 1A). The user device 105 may be configured to automatically download data changes from the server when it initially accesses the database or when it performs automatic refreshment operations (e.g. updates previously downloaded data). As used herein, the phrase “automatic refreshment operations” means that user device 105 may be configured to refresh the contents of a displayed map by automatically downloading map content data from the data base after a predetermined period of time has elapsed. Additionally, the phrase “automatic refreshment operations” also includes user-initiated or server-initiated refreshment operations. Examples of service vendor data that may be stored in the information database 118 include, but are not limited to service vendor: name, address, phone number, pricing information, driving directions, coupon information, logo information, etc.

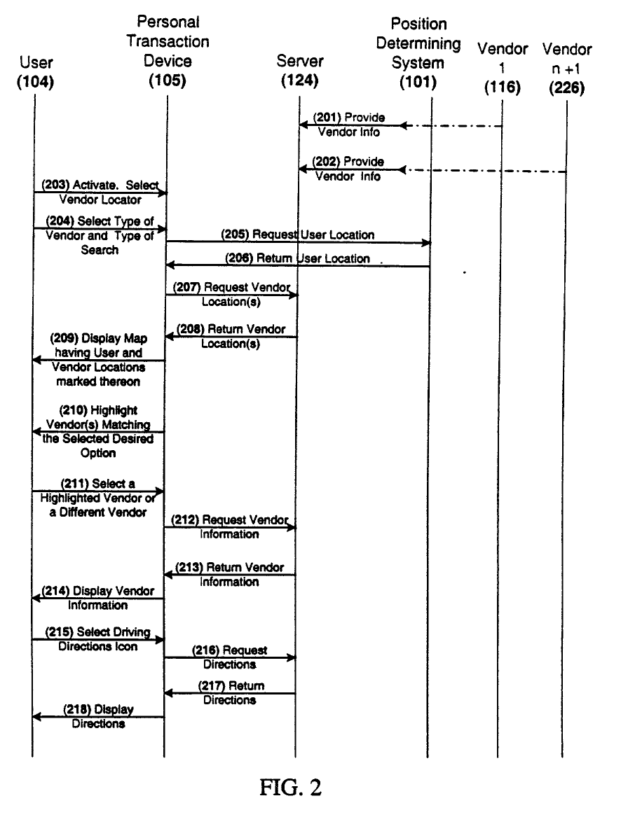

FIG. 2 is a process chart depicting one embodiment of a process to perform a transaction using the user device 105. In FIG. 2, at least six entities are represented: the user 104, the user device 105, the remote server 124, the Position Determining System (PDS) 101, and two service vendors, Service Vendor N 116, and Service Vendor N+1 226.

To begin, service vendors N 116 through N+1 226(N being an integer greater than zero) submit service vendor information to a information database (operations 201 and 202). In one embodiment, the information database is selectively coupled with user device 105 and hosted by the remote server 124 (of FIG. 1A). At operation 203, the user 104 activates user device 105 and selects a service vendor locator program, as previously described and described in further detail below. Once the program loads, the user selects the type of service vendor to locate, as well as the type of search to be performed (operation 204). For illustrative purposes, user device 105 is shown and described as selectively coupling to PDS 101. At this point, however, the user device 105 may selectively couple with either PDS 101 or to the information database at the remote server 124. At operation 205, user device 105 requests its current location from PDS 101, and receives a reply (operation 206). At operation 207, user device 105 selectively couples with the information database and requests a map of the local area, together with the grid coordinates, logos, pricing information, etc., of the service vendors. The requested information is returned to the user device 105 at operations 208 and 209.

Once the requested information has been received, the service vendor locator program displays and superimposes on the map's graphical interface, icons indicating the locations of the service vendors and the user device itself as previously described. In one embodiment, service vendor icons matching the results of a particular search query, such as “find lowest price,” are highlighted or otherwise brought to the user's attention (operation 210). Real-time information, such an estimated distance separating the user device from a service vendor, and estimated travel time or required to traverse that Distance may be displayed.

At operation 211, a user may select a highlighted service vendor or a different service vendor by activating the service vendor's logo or service vendor hyperlink as described above. In response, the user device 105 retrieves the requested service vendor-specific information from the information database (operations 212 and 213), and displays the information for the user (operation 214). When a driving directions icon or hyperlink is activated, the user device 105 retrieves the directions from the information database and displays them for the user (operations 215 to 218).

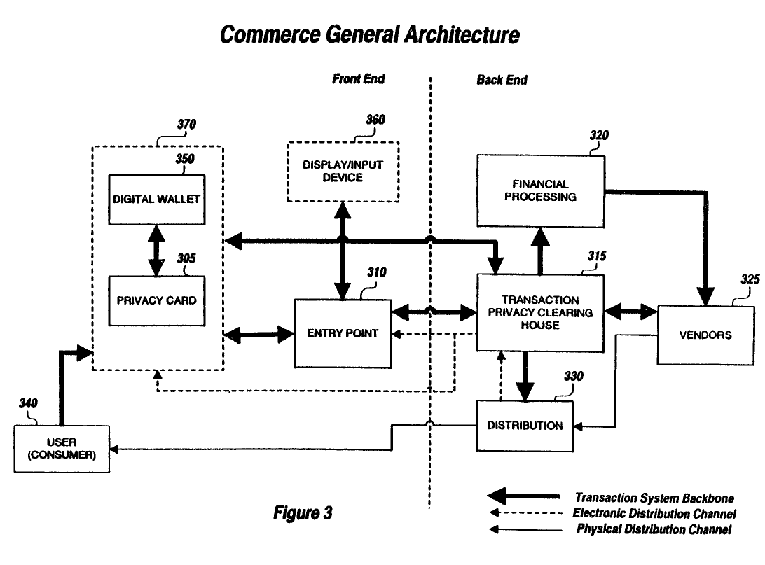

FIG. 3 is a block diagram of one embodiment of a secure transaction system, which is suitable for use as the remote server 124 (of FIG. 1A) and which also may be used in electronic commerce. In this embodiment, a transaction privacy clearing house (TPCH) 315 interfaces a user (consumer) 340 and a vendor 325. In this particular embodiment, the user device 105 is illustrated as a personal transaction device (PTD) 370, e.g., a privacy card 305, (or a privacy card 305 coupled to a digital wallet 350), which is used to maintain the privacy of the user while enabling the user to perform transactions. In an alternate embodiment, the PTD 370 may be any suitable device that allows unrestricted access to TPCH 315. The personal transaction device information is provided to the TPCH 315 that then indicates to the vendor 325 and the user 340 approval of the transaction to be performed.

In order to maintain confidentiality of the identity of the user 340, the transaction device information does not provide user identification information. Thus, the vendor 325 or other entities do not have user information but rather transaction device information. The TPCH 315 maintains a secure database of transaction device information and user information. In one embodiment, the TPCH 315 interfaces to at least one financial processing system 320 to perform associated financial transactions, such as confirming sufficient funds to perform the transaction, and transfers to the vendor 325 the fees required to complete the transaction. In addition, the TPCH 315 may also provide information through a distribution system 330 that, in one embodiment, can provide a purchased product to the user 340, again without the vendor 325 knowing the identification of the user 340. In an alternate embodiment, the financial processing system 320 need not be a separate entity but may be incorporated with other functionality. For example, in one embodiment, the financial processing system 320 may be combined with the TPCH 315 functionality.

In one embodiment, the financial processing system (FP) 320 performs tasks of transferring funds between the user's account and the vendor's account for each transaction. In one embodiment, the presence of the TPCH 315 means that no details of the transactions, other than the amount of the transactions and other basic information, are known to the FP 320. The TPCH 315 issues transaction authorizations to the FP 320 function on an anonymous basis on behalf of the user over a highly secure channel. The FP 320 does not need to have many electronic channels receiving requests for fund transfer, as in a traditional financial processing system. In one embodiment, a highly secure channel is set up between the TPCH 315 and the FP 320. Thus, the FP 320 is less vulnerable to spoofing.

In one embodiment, the FP 320 is contacted by the TPCH 315 requesting a generic credit approval of a particular account. Thus, the FP 320 receives a minimal amount of information. In one embodiment, the transaction information, including the identification of goods being purchased with the credit need not be passed to the FP 320. The TPCH 315 can request the credit using a dummy charge ID that can be listed in the monthly credit statement sent to the user, so that the user can reconcile his credit statement. Further, the personal transaction device 305 can include functionality to cause the credit statement to convert the dummy charge ID back to the transactional information so that the credit statement appears to be a conventional statement that lists the goods that were purchased and the associated amount charged.

A display input device 360 (shown in phantom) may be included to enable the user, or in some embodiments the vendor 325, to display status and provide input regarding the PTD 305 and the status of the transaction to be performed.

In yet another embodiment, an entry point 310 interfaces with the personal transaction device 370 and also communicates with the TPCH 315. The entry point 310 may be an existing (referred to herein as a legacy POS terminal) or a newly configured point of sale (POS) terminal located in a retail environment. The user 340 uses the PTD 370 to interface to the POS terminal in a manner similar to how credit cards and debit cards interface with POS terminals. The entry point 310 may also be a public kiosk, a personal computer, or the like.

The system described herein also provides a distribution functionality 330 whereby products purchased via the system are distributed. In one embodiment, the distribution function 330 is integrated with the TPCH 315 functionality. In an alternate embodiment, the distribution function 330 may be handled by a third party. Utilizing either approach, the system ensures user privacy and data security. The distribution function 330 interacts with the user through PTD 330 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 370 to change the shipping address of the product at any time during the distribution cycle.

A user connects to and performs transactions with an a secure transaction system (such as shown in FIG. 3) through a personal transaction device (PTD) that has a unique identifier (ID). In one embodiment, a privacy card is used. In an alternate embodiment a digital wallet is used. In yet another alternate embodiment, a privacy card in conjunction with a digital wallet is used.

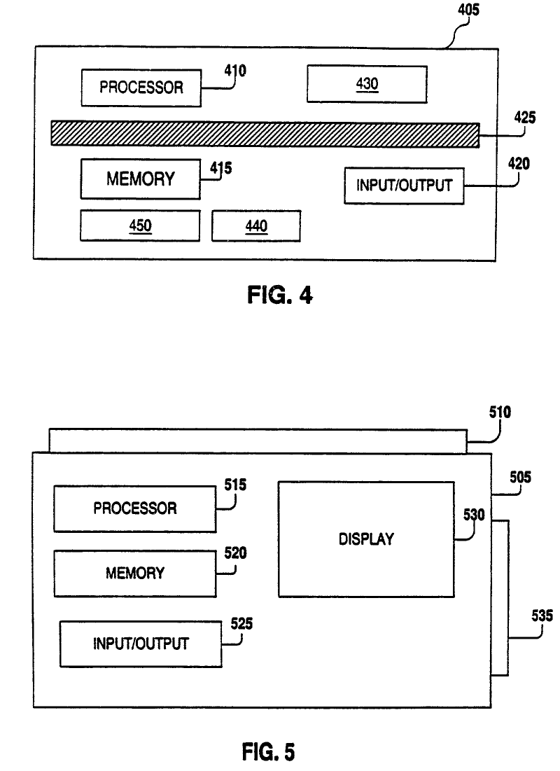

One embodiment of a privacy card 405 is illustrated in FIG. 4. In one embodiment, the card 405 is configured to be the size of a credit card. The privacy card includes a processor 410, memory 415 and input/output logic 420. The processor 410 is configured to execute instructions to perform the functionality herein. The instructions may be stored in the memory 415. The memory is also configured to store data, such as transaction data and the like. In one embodiment, the memory 415 stores the transaction ID used to perform transactions in accordance with the teachings of the present invention. Alternately, the processor may be replaced with specially configured logic to perform the functions described here.

The input/output logic 420 is configured to enable the privacy card 405 to send and receive information. In one embodiment, the input/output logic 420 is configured to communicate through a wired or contact connection. In another embodiment, the logic 420 is configured to communicate through a wireless or contactless connection. A variety of communication technologies may be used. In one embodiment, a display is used to generate bar codes scannable by coupled devices and used to perform processes as described herein. The privacy card 405 may also include a magnetic stripe generator 440 to simulate a magnetic stripe readable by devices such as legacy POS terminals.

In one embodiment, biometric information, such as fingerprint recognition, is used as a security mechanism that limits access to the card 405 to authorized users. A fingerprint touch pad and associated logic 430 is therefore included in one embodiment to perform these functions. Alternately, security may be achieved using a smart card chip interface 450, which uses known smart card technology to perform the function.

Memory 415 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 415 can also have user identity/account information block. The user identity/account information block stores data about the user and accounts that are accessed by the card. The type of data stored includes the meta account information used to identify the account to be used.

One embodiment of a digital wallet 505 is illustrated in FIG. 5. The digital wallet 505 includes a coupling input 510 for the privacy card 405, processor 515, memory 520, input/output logic 525, display 530 and peripheral port 535. The processor 515 is configured to execute instructions, such as those stored in memory 520, to perform the functionality described herein. Memory 520 may also store data including financial information, eCoupons, shopping lists and the like. The digital wallet may be configured to have additional storage. In one embodiment, the additional storage is in a form of a card that couples to the device through peripheral port 510.

In one embodiment, the privacy card 405 couples to the digital wallet 505 through port 510; however, the privacy card 405 may also couple to the digital wallet 505 through another form of connection including a wireless connection. Input/output logic 525 provides the mechanism for the digital wallet 505 to communicate information. In one embodiment, the input/output logic 525 provides data to a point-of-sale terminal or to the privacy card 405 in a pre-specified format. The data may be output through a wired or wireless connection.

The digital wallet 505 may also include a display 530 for display of status information to the user. The display 530 may also provide requests for input and may be a touch sensitive display, enabling the user to provide the input through the display. The physical manifestation of many of the technologies in the digital wallet 505 will likely be different from those in the privacy card 405, mainly because of the availability of physical real estate in which to package technology. Examples of different physical representations would include the display, fingerprint recognition unit, etc.

The components of a secure transaction system illustrated in FIGS. 3, 4, and 5 are further described in PCT published patent application number U.S. Pat. Ser. No. 00/35619, which is assigned to the same assignee as the present application and which is hereby incorporated by reference.

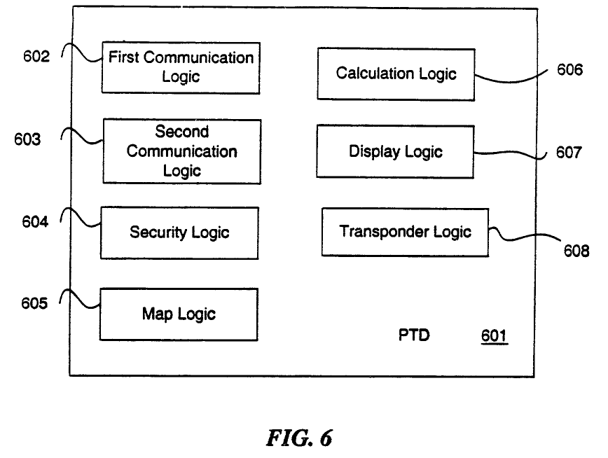

FIG. 6 illustrates another embodiment of a personal transaction device suitable for use as user device 105. The PTD 601 may include a transaction device identifier, the identifier providing no apparent identification of a use authorized to user the PTD 601. In one embodiment, PTD 601 may include a first communication logic 602 configured to communicate the transaction device identifier to perform a transaction to an electronic commerce system that includes a secure mechanism for correlating the device identifier and user identification. A security logic 604 may be included in the PTD and configured to allow an authorized user to use the PTD to perform a transaction. The PTD may further include a second communication logic 603 configured to communicate with a position determining system and an information database. Additionally, the PTD may include a logic 605 configured to display on a map a variable position of the PTD together with a fixed service vendor location, and other information. The PTD may also include a calculation logic 606 configured to calculate the variable Distance and travel time between the variable position of the PTD and a fixed service vendor location.

In one embodiment, PTD 601 may also include a display logic 607 to display the map and other information for the user. In another embodiment, transponder logic 608 may be included to enable PTD 601 to communicate with a service vendor's system. The transponder logic 608 may be a universal transponder, or a plurality of service vendor specific transponders, that enables payments to be made automatically and wirelessly. An example of wireless gasoline transactions is the radio-frequency-based Speedpass™ system used by Mobil Oil, in which miniature radio transponders controlled by the consumer automatically transmit unique, secure ID numbers to an electronic system located in the pump to automatically charge purchases to a designated credit card.

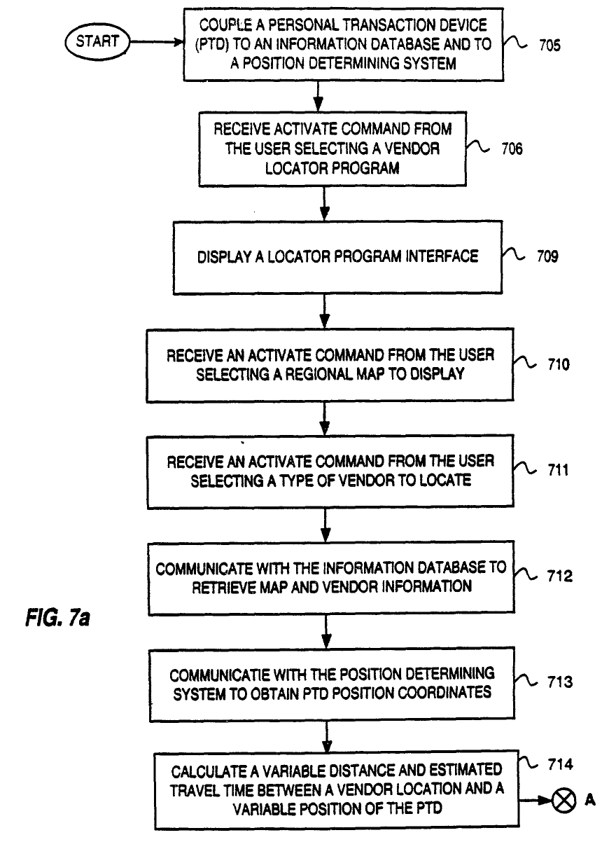

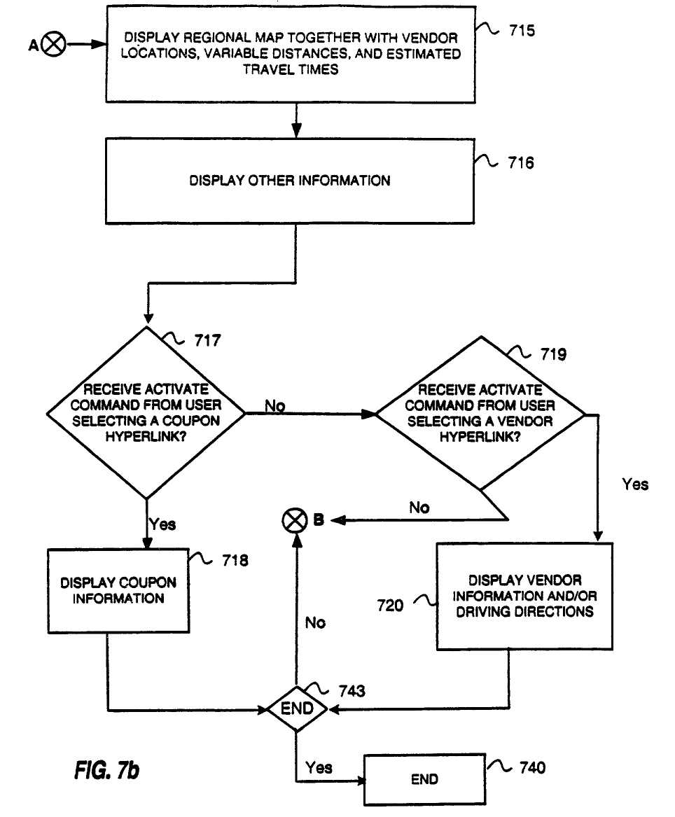

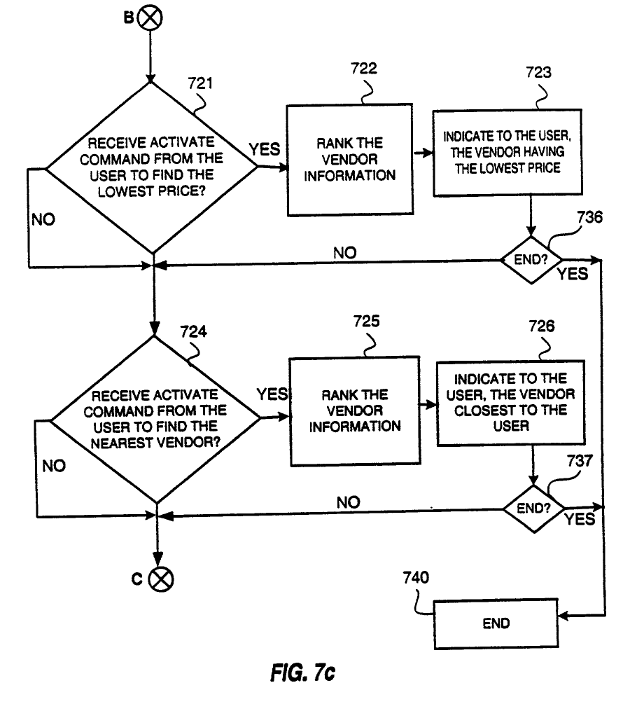

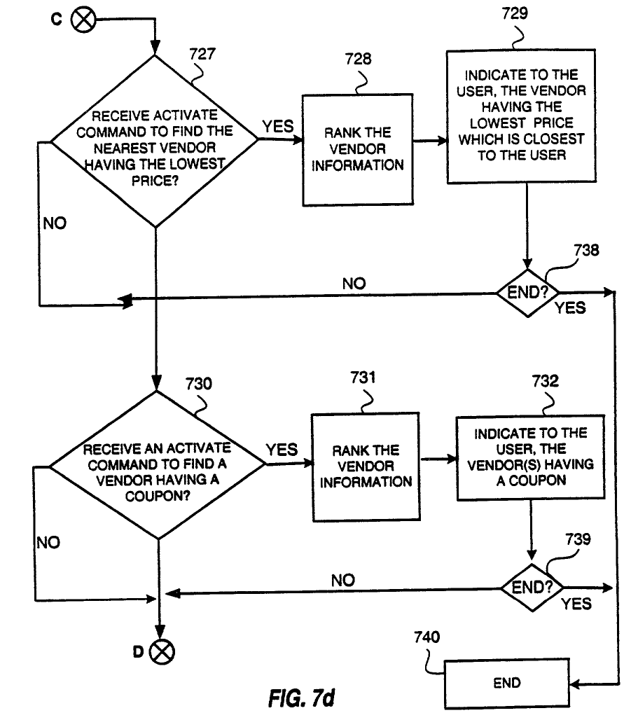

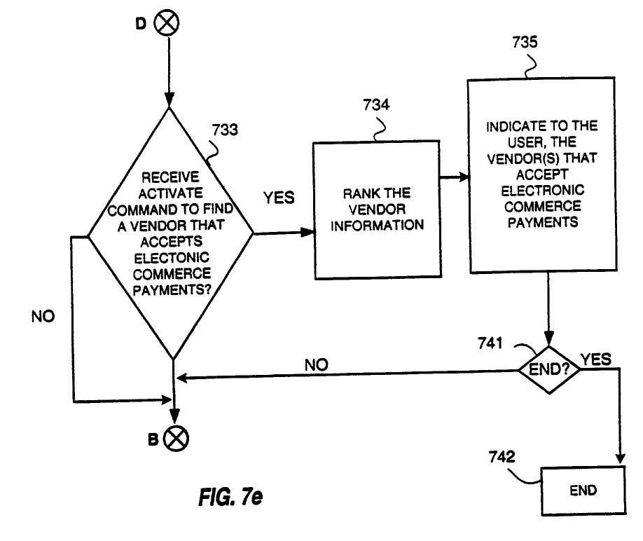

FIG. 7A is one embodiment of a method 700 performed by a user device 105 (of FIG. 1A) to provide service vendor information to the user. The method begins at block 705 by selectively coupling the user device to an information database and to a position determining system. At block 706 an activate command from the user is received that selects a service vendor locator program. A service vendor locator program interface is displayed for the user at block 709. Block 710 represents receiving an activate command from the user that selects a regional map to display. Block 711 represents receiving an activate command from the user selecting a type of service vendor to locate. In one embodiment, the method 700 communicates with the information database to retrieve the selected regional map and service vendor information at block 712. At block 713 the method 700 communicates with the position determining system to receive the position coordinates of the user device. An estimated distance and an estimated travel time between a service vendor locations and a variable position of the user device are calculated at block 714. The method 700 continues to block 715 shown in FIG. 7B.

At block 715, the selected regional map having service vendor, variable distances, estimated travel times, and other information displayed thereon, is displayed on a display screen associated with the user device. At block 716, other information, such as price and coupon information, service vendor logos, etc., is displayed on another part of the display screen. At decision block 717, the method 700 determines whether an activate command is received from the user that selects a Coupon hyperlink. In another embodiment, the method 700 continues to decision block 719. In a further embodiment, the coupon information is displayed on the display screen at block 718, and the method 700 continues to decision block 743, where it determines whether the user desires to terminate the method. If yes, the method 700 ends at block 740. If no, the method 700 continues to decision block 721 shown in FIG. 7C.

Referring again to decision block 719, the method 700 determines whether an activate command is received from the user that selects a service vendor hyperlink. If not, the method continues to block 721. If yes, the service vendor information and/or driving direction are displayed on the display screen for the user at block 720, and method 700 continues to decision block 743 where the method ends.

Referring now to FIG. 7C, at decision block 721 the method 700 determines whether an activate command is received from the user to find the lowest price. If not, the method continues to decision block 724 as described below. If yes, the service vendor information is sorted and ranked at block 722, and the service vendor having the lowest price is indicated to the user (Block 723). At decision block 736 it is determined whether the user desires to terminate the method. If yes, the method terminates at end block 740. If not, the method continues to decision block 724, where it is determined whether an activate command from the user to find the nearest service vendor is received. If not, the method 700 continues to decision block 727 shown in FIG. 7D and described below. If yes, the service vendor information is sorted and ranked at block 725, and the service vendor closest to the user is indicated to the user at block 726. The method 700 continues to decision block 737, where the method 700 determines whether the user desires to terminate the method. If yes, the method ends at block 740. If not, the method continues to decision block 727 shown in FIG. 7D, where it is determined whether an activate command from the user is received to find the nearest service vendor having the lowest price. If not, the method continues to decision block 730 described below. If yes, the service vendor information is sorted and ranked at block 728, and the service vendor closest to the user having the lowest price is indicated to the user at block 729.

The method 700 continues to decision block 738 where it determines whether the user desires to terminate the method. If yes, the method 700 terminates at end block 740. If not, the method 700 continues to decision block 730, where it determines whether an activate command is received from the user to find a service vendor having a coupon. If not, the method continues to decision block 733 shown in FIG. 7E and described below. If yes, the service vendor information is sorted and ranked at block 731, and the service vendor or service vendors, having a coupon, are indicated to the user at block 732.

The method continues at decision block 739 where it determines whether the user desires to terminate the method. If yes, the method ends at block 740. If not, the method continues at decision block 733, where it determines whether an activate command is received from the user to find a service vendor that accepts electronic commerce payments. If not, the method loops back to block 715 in FIG. 7B and the method continues as described above until terminated by the user. If yes, the service vendor information is sorted and ranked at block 734, and the service vendor or service vendors that accept electronic commerce payments are indicated to the user at block 735. At decision block 741 the method determines whether the user desires to terminate the method. If yes, the method terminates at block 742. If not, the method 700 loops back to block 715 shown in FIG. 7B as described above, until terminated by the user.

It will be appreciated that that more or fewer processes may be incorporated into the method(s) illustrated in FIGS. 7A-7E without departing from the scope of the invention and that no particular order is implied by the arrangement of blocks shown and described herein. It further will be appreciated that the method(s) described in conjunction with FIGS. 7A-7E may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods.

For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

The invention has been described in conjunction with various embodiments. It is evident that numerous alternatives, modifications, variations and uses will be apparent to those skilled in the art in light of the foregoing description. In particular, although the user device has been described in the context of Internet and point of sale (POS) networks, it will be appreciated that the invention is not limited to these particular networks, and are applicable to any network that is configured to perform a transaction.

Additionally, while the user device has been described as including a privacy feature in which no links or records are kept that relate items purchased with a specific user identity except in one highly secure location, it is contemplated that the user device will operate with a variety of types of electronic commerce systems including those which do not provide a privacy feature as described herein.

What is claimed is:

1. A system, comprising:
a device to couple to a position determining system to determine relative positions of a service vendor and the device, the device including a device identifier to authorize a transaction without revealing the identity of a user of the device;
an information database to couple to the device to provide the device with information about the service vendor; and
a display coupled to the device to display the relative positions and the information about the service vendor on a map.

2. The system of claim 1 wherein the device is a personal transaction device.

3. The system of claim 1, wherein the device is configured to provide the device identifier to a transaction privacy clearing house (TPCH) via a point of sale (POS) terminal when the device is coupled to the POS terminal.

4. The system of claim 1 wherein the POS terminal is a service vendor terminal.

5. The system of claim 4 wherein the service vendor is selected from the group consisting of a gas station, a hotel, an airline, a merchant, and a restaurant.

6. The system of claim 1 wherein the position determining system is a Global Positioning System (GPS).

7. The system of claim 1 wherein the display has a first part to display the map and a second part to display service vendor data and other data.

8. The system of claim 7 wherein a portion of the service vendor data and a portion of the other data is displayed in real-time on the map.

9. The system of claim 8 wherein the service vendor data comprises pricing information, location information, coupon information, and driving instructions.

10. The system of claim 8 wherein the other data comprises a numerical representation of a relative distance between the service vendor and the device.

11. The system of claim 10 wherein the numerical representation comprises a first number representing an estimated distance in miles or kilometers separating the device from a service vendor location, and further comprises a second number representing an estimated travel time required to traverse the estimated distance.

12. The system of claim 1 wherein the position determining system is a vehicle's onboard navigation system.

13. The system of claim 1 wherein the device is selected from the group consisting of a privacy card, a digital wallet, and a privacy card configured to be coupled to a digital wallet.

14. The system of claim 1 wherein the device further comprises a biometric security device.

15. The system of claim 14 wherein the biometric security device comprises a fingerprint scanner.

16. The system of claim 1 wherein the device further comprises a magnetic stripe mechanism to read and encode a magnetic stripe of one of a credit card, a smart card, or a privacy card.

17. An electronic user device for locating service vendors and performing transactions, the device comprising:
a communication logic to communicate with a position determining system to determine relative positions between the device and a vendor, and further to transmit a device identifier to authorize a transaction without revealing an identity of a user of the device; and
a mapping logic coupled to the communication logic to display relative positions of the device and a service vendor on a map.

18. The device of claim 17, further comprising:
a security logic to authenticate the user and further coupled to the communication logic to establish a secure communication channel.

19. The device of claim 17, further comprising:
a display coupled to the mapping logic for displaying the map.

20. The device of claim 19, wherein a correlation between the identity of the user and the device identifier is maintained separate from the personal transaction device and is used to authorize a transaction.

21. The device of claim 20, wherein the correlation is stored in a transaction privacy clearing house (TPCH).

22. The device of claim 17, wherein the communication logic is further configured to communicate with an information database to retrieve data for the service vendor, and wherein the mapping logic is further calculated to display the data for the service vendor on the map.

23. The device of claim 17, further comprising:
calculation logic coupled with the communication logic and configured to calculate an estimated relative distance and a corresponding estimated travel time between the device and the service vendor.

24. The device of claim 17 wherein the communication logic is selected from the group consisting of a smart card chip interface, a magnetic stripe, and a wireless connection.

25. A method to enable a user to locate a service vendor, the method comprising:
coupling a user device to a position determining system, the device including a device identifier to authorize a transaction without revealing the identity of the user; and
displaying a location for a service vendor obtained from the position determining system relative to a position for the device.

26. The method of claim 25, further comprising:
retrieving a map from an information database; and
displaying the map on a display screen coupled to the device.

27. The method of claim 26, further comprising:
displaying other information on the display screen.

28. The method of claim 27 wherein displaying the other information further comprises:
calculating a relative distance and a corresponding estimated travel time between the device and a service vendor; and
displaying the relative distance and corresponding estimated travel time for a user.

29. The method of claim 27 wherein the other information is selected from the group consisting of service vendor logos, service vendor prices, service vendor specific hyperlinks, and service vendor coupon hyperlinks.

30. The method of claim 25, further comprising:
conducting an electronic commerce transaction with a service vendor using the device without requiring a user of the device to reveal personal identification information to the service vendor.

31. The method of claim 25 wherein the position determining system is a Global Positioning System.

32. The method of claim 25 wherein the position determining system is a vehicle's onboard navigation system.

33. The method of claim 25, further comprising:
contacting a financial processing system to transfer funds in an amount associated with a transaction from an account for the user to an account of a service vendor.

34. The method of claim 25, further comprising:
activating a transponder associated with the device to conduct an electronic commerce transaction with a point-of-sale terminal.

35. The method of claim 25 further comprising:
using the device to locate a closest service vendor.

36. The method of claim 25 further comprising:
using the device to locate a lowest price commodity.

37. The method of claim 36 wherein the commodity is gasoline.

38. The method of claim 25 further comprising:
using the device to locate a closest service vendor having a lowest priced commodity.

39. The method of claim 25, further comprising:
using the device to locate a service vendor that accepts electronic commerce payments.
